(19) United States
(12) Patent Application Publication
(10) Pub. No.: US 2024/0412285 A1
(43) Pub. Date: Dec. 12, 2024

(54) Heppner Fletcher ExAlt Plan™ - Computer-Implemented Integrated Liquidity System and Methodology for Exchanging Alternative Assets

(71) Applicants: Brad K. Heppner, Dallas, TX (US); The Beneficient Company Group (USA), L.L.C., Dallas, TX (US)

(72) Inventors: Brad K. Heppner, Dallas, TX (US); Derek Fletcher, Parker, TX (US)

(21) Appl. No.: 18/415,919

(22) Filed: Jan. 18, 2024

Related U.S. Application Data
(63) Continuation of application No. 17/972,044, filed on Oct. 24, 2022, now abandoned.
(60) Provisional application No. 63/324,183, filed on Mar. 28, 2022.

(51) Int. Cl. G06Q 40/03; G06Q 40/04

(52) U.S. Cl. CPC G06Q 40/03; G06Q 40/04

(57) ABSTRACT

Disclosed are computer-implemented integrated system and methodology for delivering liquidity through the structured exchange of alternative assets.

### CROSS-REFERENCE TO RELATED APPLICATIONS

The present application is a continuation of U.S. patent application Ser. No. 17/972,044, filed Oct. 24, 2022, which claims the benefit of and priority to U.S. Provisional Application No. 63/324,183, filed Mar. 28, 2022. The entire contents of each of the foregoing applications are hereby incorporated by reference herein.

### TECHNICAL FIELD

The present disclosure relates to the exchange of alternative and/or illiquid assets, and more particularly, to systems and methods for providing the holders of such alternative and/or illiquid assets increased liquidity through a structured exchange of alternative and/or illiquid assets for consideration.

### BACKGROUND

The efficient exchange of assets is an integral part of a functioning financial system. Certain assets have robust markets that provide liquidity to asset holders in exchange for such assets. Marketable equity and debt securities, commodity contracts, and certain derivatives of those instruments, are examples of liquid assets with robust markets. Readily available liquidity to exchange for assets frees up capital that can be redeployed efficiently elsewhere. Efficient, available liquidity improves the overall functionality of a financial system.

While certain asset classes have sufficient liquidity provided through robust markets, other asset classes do not. For example, artwork is an example of an illiquid asset with indefinite, long transaction horizons, valuation challenges, and limited and inefficient markets. To improve the effective functioning of financial systems, there is demand for increasing the liquidity with respect to certain asset classes which do not have robust or efficient markets and are generally considered to be illiquid.

### SUMMARY

The present disclosure relates to systems and methods for providing increased liquidity through a structured exchange of an interest in an alternative and/or illiquid assets for consideration. Various terms below may be capitalized to indicate an identification. Unless otherwise indicated, such capitalization is not intended to limit the capitalized term to a particular definition or meaning.

In aspects of the present disclosure, a computer-implemented method includes conveying an interest in an alternative asset from the alternative asset holder to a Custody Trust either by direct conveyance or conveyance through at least one intermediate trust, receiving by a Funding Trust certain loan proceeds from a loan provided by a lender to the Funding Trust, such lender having no direct interest in the alternative asset, conveying at least a portion of such loan proceeds from the Funding Trust to an intervening trust, acquiring consideration based on at least a portion of the loan proceeds, and conveying the consideration to the alternative asset holder as remuneration for the interest in the conveyed alternative asset.

In various embodiments of the computer-implemented method, the conveying of the interest in the alternative asset to the Custody Trust is a conveyance through two intermediate trusts.

In various embodiments of the computer-implemented method, the lender has no control of the two intermediate trusts.

In various embodiments of the computer-implemented method, the two intermediate trusts may have the same trustee.

In various embodiments of the computer-implemented method, the Custody Trust and the Funding Trust are the same trust.

In various embodiments of the computer-implemented method, the two intermediate trusts include a Plan Custody Trust and a LiquidTrust, where the alternative asset holder is a beneficiary of the Plan Custody Trust and the LiquidTrust is a beneficiary of the Custody Trust.

In various embodiments of the computer-implemented method, the lender may be a trustee of the Funding Trust and the intervening trust, or the lender may not be a trustee of either the Funding Trust or the intervening trust.

In various embodiments of the computer-implemented method, the Funding Trust is a beneficiary of the intervening trust such that the Funding Trust holds a beneficial interest in the intervening trust and the loan is secured by a percentage of such beneficial interest in the intervening trust.

In various embodiments of the computer-implemented method, the consideration may include all of, one of, or a mix of cash and/or marketable equity securities and/or marketable debt securities.

In various embodiments of the computer-implemented method, the computer-implemented method further includes conveying, from the Custody Trust to the Funding Trust, distributions from the alternative asset.

In various embodiments of the computer-implemented method, the computer-implemented method includes conveying distributions from the alternative asset from the Custody Trust to the Funding Trust through at least one intermediate trust and through an intervening trust.

In various embodiments of the computer-implemented method, at least a portion of such distributions is used by the Funding Trust to repay to the lender at least a portion of the loan proceeds.

In various embodiments of the computer-implemented method, a beneficiary of the Funding Trust is a third-party entity.

In various embodiments of the computer-implemented method, at least a portion of distributions are distributed by the Funding Trust to the third-party entity.

Further details and aspects of exemplary embodiments of the present disclosure are described in more detail below with reference to the appended figures.

### BRIEF DESCRIPTION OF THE DRAWINGS

FIG. 1 is a flow diagram of an exemplary operation, in accordance with aspects of the present disclosure;

FIG. 2 is a diagram of an exemplary transaction involving an alternative asset holder and a Plan Custody Trust, in accordance with aspects of the present disclosure;

FIG. 3 is a diagram of an exemplary transaction involving Plan Custody Trust and a LiquidTrust, in accordance with aspects of the present disclosure;

FIG. 4 is a diagram of an exemplary transaction involving a LiquidTrust and a Custody Trust, in accordance with aspects of the present disclosure;

FIG. 5 is a diagram of an exemplary transaction involving a Plan Custody Trust, a LiquidTrust, and a Funding Trust, in accordance with aspects of the present disclosure;

FIG. 6 is a diagram of an exemplary transaction involving a Plan Custody Trust, a LiquidTrust, a Funding Trust, and a Collective Collateral Trust, in accordance with aspects of the present disclosure;

FIG. 7 is a diagram of an exemplary transaction involving a loan and exchange of loan proceeds by and among various trusts and entities, in accordance with aspects of the present disclosure;

FIG. 8 is a diagram of an exemplary transaction involving a Plan Custody Trust, a Funding Trust, and a third party entity, in accordance with aspects of the present disclosure;

FIG. 9 is a diagram of an exemplary beneficiary arrangement involving various trusts, in accordance with aspects of the present disclosure;

FIG. 10 is a flow diagram of an exemplary operation of a trustee of the Plan Custody Trust; and

FIG. 11 is a diagram of an exemplary computing system.

### DETAILED DESCRIPTION

The present disclosure relates to systems and methods for providing increased liquidity through a structured exchange of an interest in an alternative and/or illiquid assets for consideration. Unless otherwise specified or otherwise indicated by the context, the term “alternative asset” is used herein to mean and include any type of asset that does not have a market by which a holder-of-interests can exchange its interests in the asset for financial remuneration at a time desired by the holder-of-interests. The term “illiquid asset” may be used interchangeably with “alternative asset.” Examples of alternative assets include, without limitation, interests in private equity, venture capital, leveraged buyouts, structured credit, private debt, real estate, feeder funds, fund of funds, life insurance policies, natural resources, non-traded business development companies, non-traded real-estate investment trusts, and/or other intangible assets, among other things. Various terms below may be capitalized to indicate an identification. Unless otherwise indicated, such capitalization is not intended to limit the capitalized term to a particular definition or meaning.

Aspects of the present disclosure operate to provide increased liquidity for a holder of interests in an alternative asset by facilitating the exchange of such holder's interests in the alternative asset for financial remuneration. Treatment of such an exchange under certain regulations and other market inefficiencies may cause undesirable delays or onerous obligations for the transacting parties, and aspects of the present disclosure operate to structure the transactions so that such delays or obligations do not apply to the exchange of alternative assets. For example, aspects of the present disclosure provides for a funding party that provides funds, a portion of which are employed to facilitate the delivery of financial remuneration for such holder of interests in an alternative asset, but such funding party neither holds the interests in the alternative asset nor manages the alternative asset for its own benefit following the transaction. Rather, interests in the alternative asset are held by a third-party trust to which the funding party may serve as trustee or an administrator but not as an owner or controlling party.

As mentioned above, aspects of the present disclosure operate to structure the transactions so that such delays or onerous obligations do not apply to the exchange of alternative assets for consideration. The transactions are described below in connection with various figures. The description and figures are intended to be examples of systems and methods according to the present disclosure, and it will be understood that such examples do not limit the scope of the present disclosure.

In connection with the transactions described below, the following terms have the following meanings.

The term “asset” means and includes anything of value, including any property, whether it is real, personal, fixed, intangible, monetary, or otherwise.

The term “interest” means and includes any legal right in or to an asset.

The term “beneficial interest” means and includes the interests that a beneficiary of a trust has in any benefits of the trust.

Additionally, terminology used in connection with a trust, such as grantor, settlor, trustee, and beneficiary, among other terms, shall have established meanings which persons skilled in the art will understand.

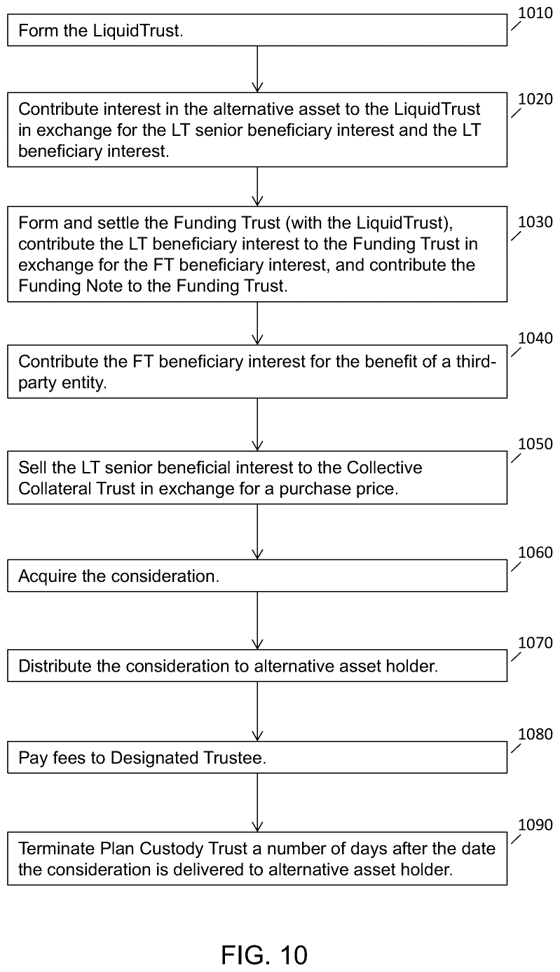

The drawings and description below relate to various transactions. Although various transactions are presented in a particular sequence, such transactions or portions of transactions can be implemented in a different sequence than as described or illustrated herein. Additionally, various transactions or portions of transactions can be implemented concurrently or simultaneously. Portions of one or more transactions can be implemented in one or more other transactions and/or can be implemented differently than as illustrated or described. The illustrations and descriptions herein may describe transactions involving an alternative asset. It is contemplated that such disclosure can be applied sequentially, concurrently, or simultaneously to more than one alternative asset. The transactions described herein can be implemented by a computing system, which will be described in connection with FIG. 10.

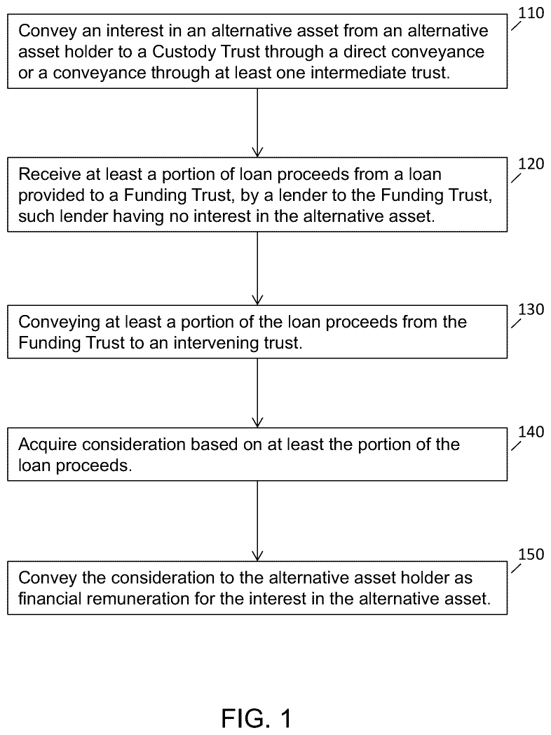

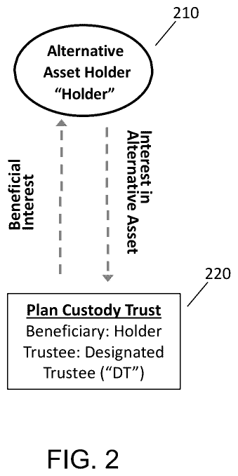

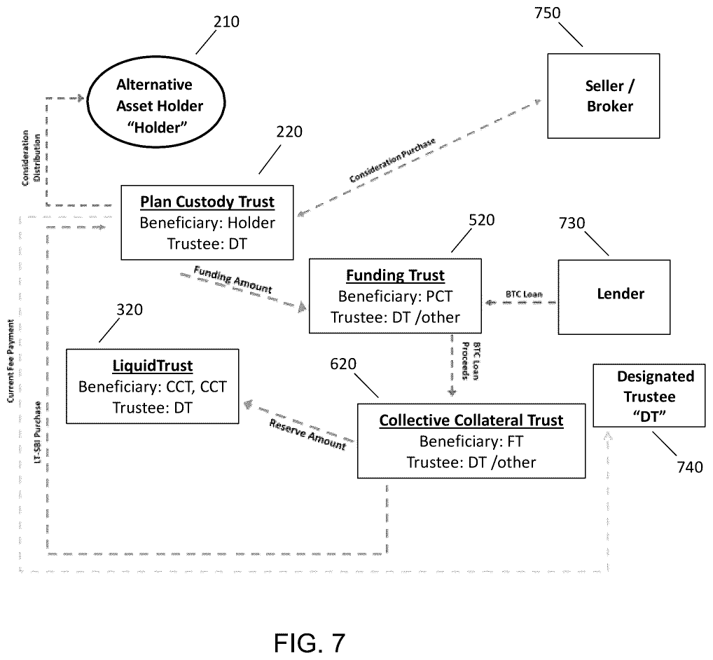

Referring now to FIG. 1, there is shown a flow chart of an exemplary operation that can provide increased liquidity through the structured exchange of an illiquid and/or alternative asset. At block 110, the operation involves conveying an interest in an alternative asset from an alternative asset holder to a Custody Trust by direct conveyance or by conveyance through at least one intermediate trust. In various embodiments, the interest in an alternative asset can be conveyed through two intermediate trusts, as described later herein in connection with FIGS. 2-4. At block 120, the operation involves a Funding Trust receiving loan proceeds provided through a loan by a lender to the Funding Trust, where the lender has no interest in the alternative asset. In various embodiments, the lender has no control of the Custody Trust. In various embodiments, the lender may have control of the Custody Trust. An arrangement of financing from a lender in this manner provides liquidity for the structured exchange of the alternative asset while avoiding onerous obligations or time delays for the exchange transaction. Further details of such loan are described below in connection with FIG. 7. At block 130, the operation involves conveying at least a portion of such loan proceeds from the Funding Trust to an intervening trust. At block 140, the operation involves acquiring consideration, employing at least a portion of the loan proceeds. The consideration is the financial remuneration to be conveyed to the alternative asset holder in exchange for an interest in the alternative assets. In various embodiments, the consideration includes all of, one of, or a mix of, cash and/or marketable equity securities and/or marketable debt securities, among other things, and can be purchased from a broker or seller. At block 150, the operation involves conveying the consideration to the alternative asset holder as financial remuneration for the exchange of the interest in the alternative asset. Generally, the operation of FIG. 1 can enable an alternative asset to be exchanged much faster and without certain onerous legal obligations. For example, the operation of FIG. 1 can enable an alternative asset to be exchanged and the alternative asset holder to be paid in a matter of weeks, as opposed to several months or over a year, which is typical for alternative asset liquidity transactions. Further details of the operation of FIG. 1 are described below.

FIG. 2 shows exemplary transactions of a person or entity who is the holder of interests of an alternative asset. For simplicity, the person or entity will be referred to herein as an “alternative asset holder,” and it will be understood that an alternative asset holder 210 can be either a person or a legal entity. The alternative asset holder 210 serves as settlor of a trust, which is designated in FIG. 2 as Plan Custody Trust 220 and may be referred to herein as “PCT”. The alternative asset holder 210 conveys an interest in an alternative asset to the Plan Custody Trust 220, and the alternative asset holder 210 is designated the sole beneficiary of Plan Custody Trust 220. Thus, a beneficial interest in the Plan Custody Trust 220 is conveyed to the alternative asset holder 210.

In various embodiments, the trustee of the Plan Custody Trust 220 may be a trust company and will be referred to herein as “Designated Trustee.” The Designated Trustee can be a trust company or can be another form formed under the laws of any state or jurisdiction under which it may serve as trustee. The alternative asset holder 210, as settlor of the Plan Custody Trust 220, would appoint the Designated Trustee as the trustee of the Plan Custody Trust 220. In various embodiments, the Plan Custody Trust 220 is a directed trust such that the Designated Trustee cannot take administrative or discretionary action on behalf of the Plan Custody Trust 220 without the direction of alternative asset holder 210. The directed trust can be established under the laws of any state or jurisdiction.

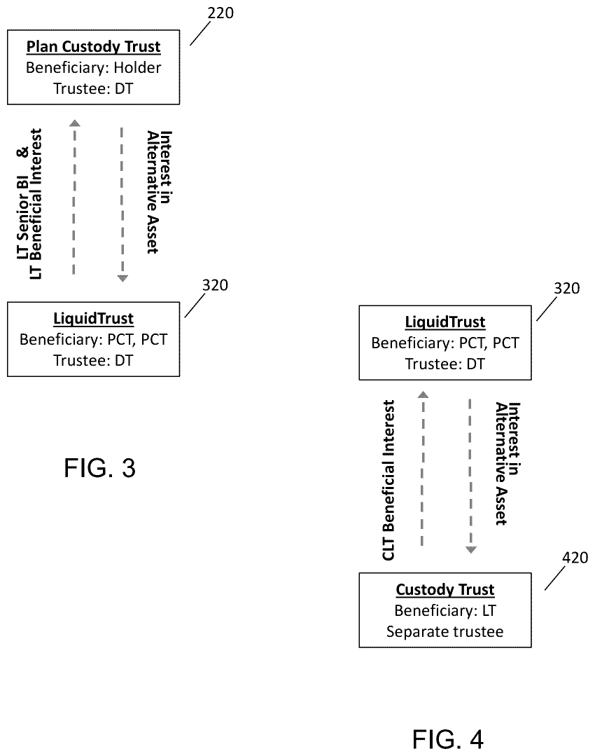

FIG. 3 shows exemplary transactions between the Plan Custody Trust 220 and a further trust 320, which is designated in FIG. 3 as LiquidTrust 320 and may be referred to herein as “LT”. The Plan Custody Trust 220 conveys its interests in the alternative asset to the LiquidTrust 320 in exchange for both a senior beneficial interest in the LiquidTrust 320 and a beneficial interest in the LiquidTrust 320. That is, the Plan Custody Trust 220 is designated as a senior beneficiary of the LiquidTrust 320 and also designated as a beneficiary of the LiquidTrust 320. As mentioned above, the trustee of the Plan Custody Trust 220 is the Designated Trustee. In the transaction of FIG. 3, the Designated Trustee also becomes as the trustee of the LiquidTrust 320. The Designated Trustee, acting as trustee of the Plan Custody Trust 220, can be the settlor of the LiquidTrust 320, can execute the trust agreement for the LiquidTrust 320, and can appoint itself as trustee of the LiquidTrust 320.

FIG. 4 shows exemplary transactions between the LiquidTrust 320 and a further trust 420, which is designated in FIG. 4 as Custody Trust 420 and may be referred to herein as “CT”. The LiquidTrust 320 conveys its interests in the alternative asset to the Custody Trust 420 in exchange for a beneficial interest in the Custody Trust 420. That is, the LiquidTrust 320 is designated as a beneficiary of the Custody Trust 420.

As mentioned above, the trustee of the LiquidTrust 320 is the Designated Trustee. In the transaction of FIG. 4, the Designated Trustee, acting as trustee of the LiquidTrust 320, can be the settlor of the Custody Trust 420, can execute the trust agreement for the Custody Trust 420 and can appoint a separate trustee for the Custody Trust 420. In various embodiments, the Custody Trust 420 can be a statutory trust or a business trust and can be a trust established under the laws of any state or jurisdiction. In various embodiments, the trustee of the Custody Trust 420 may only act on behalf of the Custody Trust 420 at the direction of the holder of the CT beneficial interest (e.g., LiquidTrust 320). After the transaction of FIG. 4, the Custody Trust 420 is the holder of interests in the alternative asset and will receive benefits relating to its interests in the alternative asset.

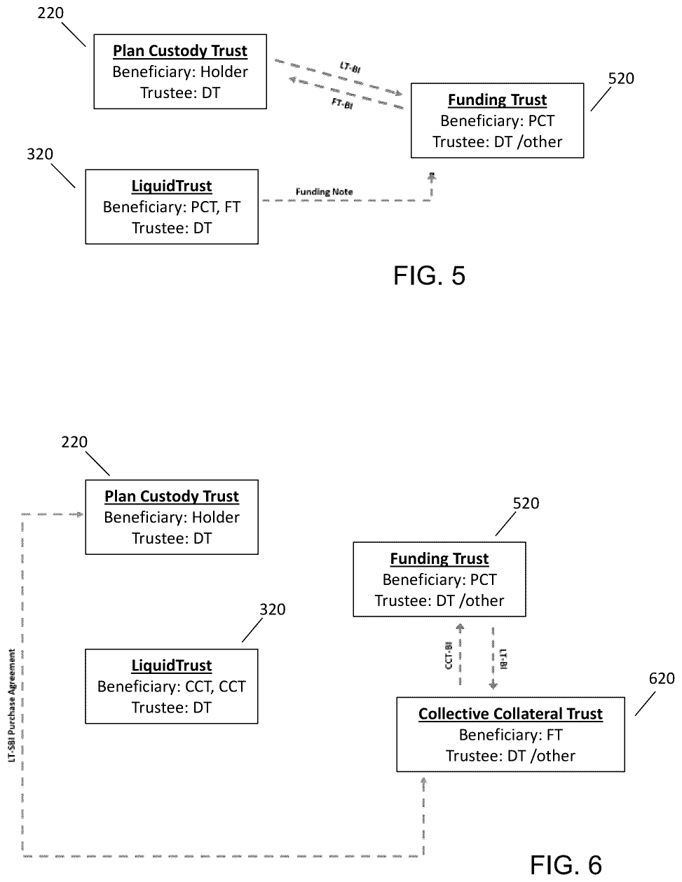

FIG. 5 shows exemplary transactions involving the Plan Custody Trust 220, the LiquidTrust 320, and a further trust 520, which is designated in FIG. 5 as Funding Trust 520 and may be referred to herein as “FT”. To co-settle the Funding Trust 520, the Plan Custody Trust 220 conveys its LT beneficial interest to the Funding Trust 520 in exchange for a beneficial interest in the Funding Trust 520. That is, the Plan Custody Trust 220 is designated as a beneficiary of the Funding Trust 520. In the illustrated embodiment, the exchange of the LT beneficial interest for the FT beneficial interest causes the Funding Trust 520 to become the beneficiary of the LiquidTrust 320. As shown in FIG. 5, the LiquidTrust 320 contributes a funding note to the Funding Trust 520 to co-settle the Funding Trust 520. The funding note is a promissory note issued by the Plan Custody Trust to the LiquidTrust.

As mentioned above, the Designated Trustee is the trustee of the Plan Custody Trust 220 and is also trustee of the LiquidTrust 320. In the transaction of FIG. 5, the Designated Trustee can be the settlor of the Funding Trust 520, can execute the trust agreement for the Funding Trust 520, and can appoint either a separate trustee for the Funding Trust or the Designated Trustee 520. In various embodiments, where another trustee is appointed, the other trustee of the Funding Trust 520 may be a trust company established under the laws of any state or jurisdiction. The Designated Trustee, as trustee for the LiquidTrust 320, can cause the LiquidTrust 320 to contribute the funding note to co-settle the Funding Trust 520.

In various embodiments, a third party unrelated to any of the foregoing entities can be appointed as an independent advisor to the Funding Trust 520. In various embodiments, the Funding Trust 520 can be a fully-directed common law trust, such that the trustee of the Funding Trust 520 cannot take any administrative or discretionary action on behalf of the Funding Trust 520 without the direction of the independent advisor to the Funding Trust 520. The fully-directed common law trust may be established under the laws of any state or jurisdiction.

FIG. 6 shows exemplary transactions involving the Plan Custody Trust 220, LiquidTrust 320, the Funding Trust 520, and a separate trust 620, which is designated in FIG. 6 as Collective Collateral Trust 620 and may be referred to herein as “CCT”. As mentioned above, the Designated Trustee or another trustee is the appointed trustee of the Funding Trust 520. In the transaction of FIG. 6, the Designated Trustee or another trustee is the trustee of the Collective Collateral Trust 620. The Designated Trustee or another trustee can be the settlor of the Collective Collateral Trust 620, can execute the trust agreement, or joinder thereto, for the Collective Collateral Trust 620, and can be appointed as trustee for the Collective Collateral Trust 620. The Collective Collateral Trust 620 can be a common law trust established under the laws of any state or jurisdiction.

In the transaction of FIG. 6, the Funding Trust 520 conveys all or a portion of its LT beneficial interest and loan proceeds to the Collective Collateral Trust 620 in exchange for a beneficial interest in the Collective Collateral Trust 620. That is, the Funding Trust 520 is designated as a beneficiary of the Collective Collateral Trust 620. In the illustrated embodiment, the exchange of the LT beneficial interest to the Collective Collateral Trust 620 causes the Collective Collateral Trust 620 to become the beneficiary of the LiquidTrust 320. The Collective Collateral Trust 620 also purchases the LT senior beneficial interest from the Plan Custody Trust 220 in exchange for a certain purchase price. Accordingly, the Collective Collateral Trust 620 may become both the senior beneficiary and the beneficiary of the LiquidTrust 320.

FIG. 7 shows exemplary transactions involving various trust and entities described above herein, including the Designated Trustee 740. In the transactions of FIG. 7, a lender 730 provides a loan to the Funding Trust 520. In various embodiments, the lender 730 is a fiduciary to the Funding Trust 520. In various embodiments, the lender 730 is not a fiduciary to the Funding Trust 520. The loan provided by the lender 730 to the Funding Trust 520 can have various terms and provisions. In various embodiments of the Loan, the Loan is provided for a particular term with a particular interest rate or variable interest rate, and with no prepayment penalty. In various embodiments, the Loan can have different durations and/or different interest rates and may not have a prepayment penalty.

In various embodiments of the Loan, the lender does not have a demand right under the Loan. In various embodiments of the Loan, the Loan is secured by a particular percentage of the Funding Trust's beneficial interest in the Collective Collateral Trust 620. In various embodiments, the Loan can be secured by different percentages that is less than 100% of the Funding Trust's beneficial interest in the Collective Collateral Trust 620.

In various embodiments of the Loan, the independent advisor to the Funding Trust 620 may be required to consider investing proceeds derived from the Funding Trust's beneficial interest in the Collective Collateral Trust 620, in lieu of making a payment on the Loan, if the independent advisor believes it is in the best interest of the beneficiary, a third-party entity.

The terms and provisions described above are exemplary. Other terms and provisions are contemplated for the Loan and are within the scope of the present disclosure.

The Funding Trust 520 receives the loan proceeds from the lender 730, and the Funding Trust 520 conveys the loan proceeds to the Collective Collateral Trust 620 in exchange for beneficial interest in the Collective Collateral Trust. In accordance with aspects of the present disclosure, the loan proceeds can be an amount that includes at least (i) a consideration amount, (ii) a current fee amount, (iii) an administrative reserve amount, and (iv) a funding amount.

As used herein, the term “consideration” refers to what the alternative asset holder 210 will receive in exchange for the alternative asset. In various embodiments, the consideration includes cash, marketable equity securities, and/or marketable debt securities, or a combination thereof. The consideration purchase price is the value of such marketable equity securities and/or marketable debt securities.

In various embodiments, the current fee amount can be equal to a percentage of: the net asset value of the alternative asset and the “unfunded capital commitment” with respect to the alternative asset, which can be payable following delivery of the consideration to the alternative asset holder 210 but prior to the termination date of the Plan Custody Trust. In various embodiments, the “unfunded capital commitment” refers to the amount of money the alternative asset holder 210 is obligated to deliver to a sponsor of the fund of the alternative asset upon a capital call by such sponsor. In various embodiments, the Custody Trust 420, which acquired the alternative asset, takes on the obligation to fund the unfunded capital commitment upon a capital call by the sponsor of the alternative asset.

In various embodiments, the reserve amount can be equal to a percentage of: net asset value of the alternative asset and the unfunded capital commitment with respect to the alternative asset.

In various embodiments, the funding amount can be equal to a percentage of: net asset value of the alternative asset and the unfunded capital commitment with respect to the alternative asset.

As shown in FIG. 7, the Collective Collateral Trust 620 conveys the reserve amount to the LiquidTrust 320 and conveys the purchase price of the LT senior beneficial interest to the Plan Custody Trust 220. In various embodiments, the purchase price of the LT senior beneficial interest is at least the sum of the consideration purchase price, the current fee amount, and the funding amount. The Plan Custody Trust 220 conveys the current fee amount to the Designated Trustee 740, conveys the funding amount to the Funding Trust 520, and, if applicable or if required, purchases the consideration from a seller or broker 750. In various embodiments, the Plan Custody Trust 220 then conveys the consideration to the alternative asset holder 210. Accordingly, in the transaction of FIG. 7, a portion of the Loan proceeds is conveyed to the LiquidTrust 320, a portion of the Loan proceeds is effectively conveyed to the alternative asset holder 210 in the form of the consideration, and a portion of the Loan proceeds is conveyed to the Designated Trustee 740. In various embodiments, the Designated Trustee 740 terminates the Plan Custody Trust 220 a number of days after delivery of the consideration to the alternative asset holder 210, such as thirty-one days or another number of days.

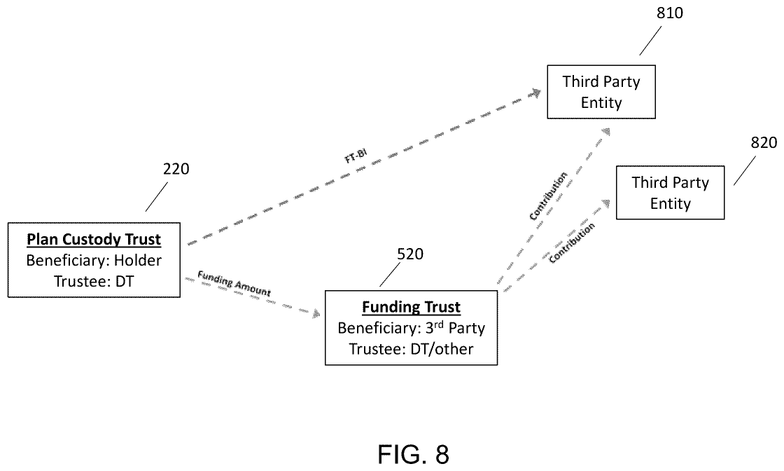

The illustrated embodiment of FIG. 7 is exemplary, and variations are contemplated to be within the scope of the present disclosure. For example, in various embodiments, the lender 730 and the Designated Trustee 740 can be affiliates, e.g., both may be subsidiaries of the same parent entity. In various embodiments, the lender 730 and the Designated Trustee 740 may be the same entity, such that the Designated Trustee 740 may be the lender 730. As another example, in various embodiments, the Designated Trustee 740, as trustee to the Plan Custody Trust 220, can contribute the FT beneficial interest to a third-party entity, which causes a third party entity to become the beneficiary of the Funding Trust 520 (as shown in FIG. 8). As another example, in various embodiments, the trustee of the Collective Collateral Trust 620 (i.e., Designated Trustee or another trustee) can contribute the LT beneficial interest to a third-party entity, such that a third-party entity becomes a beneficiary of the LiquidTrust 320 (not shown). Other variations are contemplated to be within the scope of the present disclosure.

FIG. 8 shows an exemplary transaction involving the Plan Custody Trust 220, the Funding Trust 520, and a third-party entity 810 and/or an entity 820. As mentioned above, the Plan Custody Trust 220 can contribute the FT beneficial interest to a third-party entity 810, which causes a third-party entity 810 to become the beneficiary of the Funding Trust 520. The third-party entity 810 may be a charity, a charitable organization, or another type of entity. And as mentioned above, the Plan Custody Trust 220 also contributes the funding amount to the Funding Trust 520. Because the third-party entity 810 is the beneficiary of the Funding Trust 520, the Funding Trust 520 can contribute a portion of the funding amount to the third-party entity 810. As shown in FIG. 8, the Funding Trust 520 can also contribute a portion of the funding amount to another third-party entity 820.

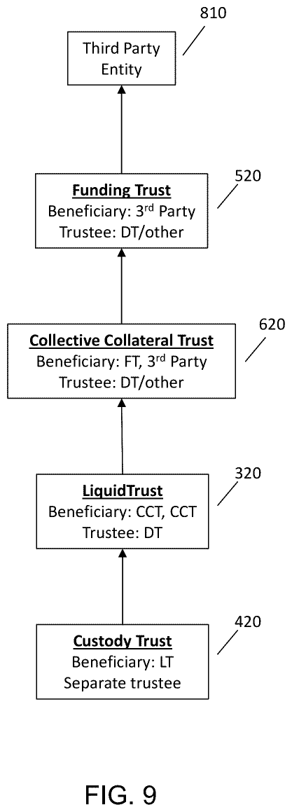

Referring now to FIG. 9, a beneficiary arrangement in accordance with aspects of the present disclosure is shown. The Custody Trust 420 holds the interest in the alternative asset, and its beneficiary is the LiquidTrust 320. The beneficiary of the LiquidTrust 320 is the Collective Collateral Trust 620. The beneficiary of the Collective Collateral Trust 620 is the Funding Trust 520. And the beneficiary of the Funding Trust 520 is a third-party entity 810.

In accordance with aspects of the present disclosure, the trustee of the LiquidTrust 320 (i.e., Designated Trustee) can have various responsibilities. For example, the Designated Trustee, as trustee of the LiquidTrust 320, can receive distributions from the Custody Trust 420 and can establish administrative reserves equal to the reserve amount, which was described above. The Designated Trustee can pay trustee, trust advisor, or trust administrator fees, and/or other third-party fees, as applicable, on behalf of itself, the Funding Trust 520, the Custody Trust 420, and/or the Collective Collateral Trust 620. Other responsibilities are within the scope of the present disclosure.

The Designated Trustee, as trustee of the LiquidTrust 320, can distribute ongoing cash flows from the interest in the alternative asset received from the Custody Trust 420, following termination of the Plan Custody Trust 220. Additionally, the Funding Trust 520 can distribute proceeds derived from distributions from the interest in the alternative assets, after the Plan Custody Trust 220 is terminated, to make payments on the Loan. As described above, in various embodiments, the Funding Trust 520 can distribute a portion of the funding amount to the third-party entity 810.

As mentioned above, the Loan is secured by a percentage (e.g., 95%) of the Funding Trust's CCT beneficial interest. In accordance with aspects of the present disclosure, the remaining percentage (e.g., 5%) of the CCT beneficial interest can be held for the benefit of the third-party entity 810 and can be unencumbered, as shown in FIG. 9. If the independent advisor to the Funding Trust 520 elects to make a payment on the Loan, a first percentage (e.g., 95%) of the payment amount is paid to the lender and a second percentage (e.g., 5%) is distributed to the third-party entity 810. If the third-party advisor to the Funding Trust 520 elects to make a distribution to the third-party entity 810, the second percentage (e.g., 5%) of the distribution amount will be made to the third-party entity 810 and the first percentage (e.g., 95%) will be paid to the lender as payment on the Loan.

Accordingly, described above are various transactions involving various trusts, trustees, advisors, and entities. FIG. 10 describes certain activities of the Designated Trustee. As described above, the Designated Trustee is trustee of the LiquidTrust 320 and owes a fiduciary duty to the beneficiaries of the Plan Custody Trust 220 and the LiquidTrust 320 or other trusts of which it serves as trustee. The activities of FIG. 10 are not comprehensive, and the Designated Trustee can engage in other activities as well.

With reference to FIG. 10, at block 1010, the Designated Trustee, as trustee of the Plan Custody Trust 220, forms the LiquidTrust 320. At block 1020, the Designated Trustee, as trustee of the Plan Custody Trust 220, contributes the interest in the alternative asset to the LiquidTrust 320 in exchange for the LT senior beneficiary interest and the LT beneficiary interest. At block 1030, the Designated Trustee, as trustee of the Plan Custody Trust 220 and trustee of the LiquidTrust 320, forms and settles the Funding Trust 520 and contributes the LT beneficiary interest to the Funding Trust 520 in exchange for the FT beneficiary interest and contributes the Funding Note to the Funding Trust. At block 1040, the Designated Trustee, as trustee of the Plan Custody Trust 220, contributes the FT beneficiary interest for the benefit of a third-party entity. At block 1050, the Designated Trustee, as trustee of the Plan Custody Trust 220, sells the LT senior beneficial interest to the Collective Collateral Trust 620 in exchange for a purchase price. At block 1060, the Designated Trustee, as trustee of the Plan Custody Trust 220, acquires the consideration to be distributed to the alternative asset holder. The consideration may be all of, any one of, or any mix of cash and/or marketable equity securities and/or marketable debt securities. If applicable or if required, the Designated Trustee may purchase all or a portion of the consideration, such as purchase marketable equity securities and/or marketable debt securities. At block 1070, the Designated Trustee, as trustee of the Plan Custody Trust 220, distributes the consideration to the alternative asset holder. At block 1080, the Designated Trustee, acting as trustee and as a fiduciary of trust beneficiaries, pays administrative fees to itself. And at block 1090, the Designated Trustee, as trustee of the Plan Custody Trust 220, terminates the Plan Custody Trust 220 a number of days after the date the consideration is delivered to alternative asset holder.

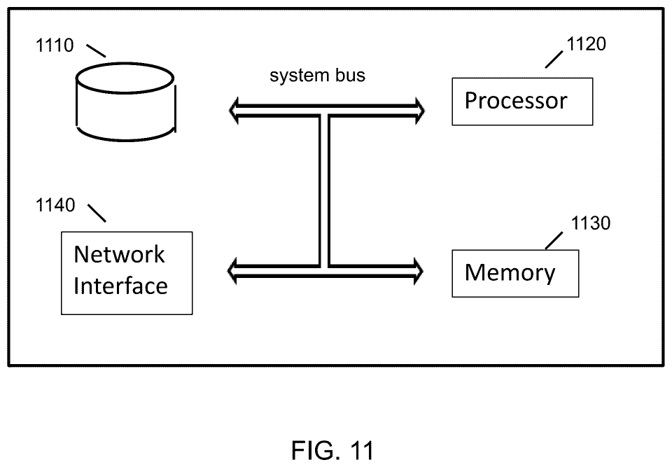

Accordingly, described above are various transactions involving various trusts, trustees, advisors, and entities. As mentioned above, the operations can be implemented by a computer system. FIG. 11 is a block diagram of an exemplary system for implementing the disclosed operations, in accordance with aspects of the present disclosure.

The system of FIG. 11 includes a database 1110, one or more processors 1120, at least one memory 1130, and a network interface 1140. In various embodiments, the computing system can be a proprietary server or can be a hosted server in the cloud. In embodiments, the computing system can be a single server or can include multiple servers in a single location or distribution across different locations.

The storage 1110 includes any device or material from which information may be accessed or reproduced, or held in an electromagnetic, optical, or other form for access by a computer processor. An electronic storage may be, for example, volatile memory such as RAM, non-volatile memory which permanently holds digital data until purposely erased (such as flash memory or solid state drives), magnetic devices such as hard disk drives, and/or optical media such as a CD, DVD, Blu-ray disc, among other storages.

In aspects of the present disclosure, the storage 1110 can store identity of an alternative asset holder, trust documents for the various trusts, account information for the Loan, account information for the various trusts, and/or financial account information for deposit and transfer funds between the various entities, among other things. The data can be stored in the storage 1010 and sent via the system bus to the processor 1120. The system bus can be localized or network-based, and the storage need not co-reside with the processor and server memory, as long as all components are in communication with each other.

The processor 1120 executes instructions that can be stored in the memory 1130 and utilizes the data from the storage 1110. The instructions can execute the operations disclosed above herein. The computing system can communicate with other devices and servers through the network interface 1140. For example, the computing system can communicate with a third party server that stores account information.

In various embodiments, the computing system of FIG. 11 can include software applications that implement the transactions and operations described above herein. For example, various transactions may be transactions or portions of transactions can be implemented in a different sequence than as described or illustrated herein. Additionally, various transactions or portions of transaction can be implemented concurrently or simultaneously. Portions of one or more transactions can be implemented in one or more other transaction. In accordance with aspects of the present disclosure, a software application can be used to specify such different arrangements and timing of transactions or portions of transactions such that different alternative asset holders can have different timing or different implementation of transactions. The software application can be used to arrange and rearrange the transactions with ease using, for example, a graphical user interface (not shown). Account information stored in the storage 1110 and the network interface 1140 can allow the pre-arranged transactions to be communicated with various entities and institutions.

In various embodiments, one or more software applications can implement an alternative asset holder and advisor-credentialed site for the initiation of liquidity requests. Alternative asset holders can provide details about alternative assets, upload asset documents, and track the progress of a transaction. They can also download a binding term sheet, when available, and request verification of accreditation.

In various embodiments, one or more software applications can implement an underwriting and risk application for documenting valuation, pricing, and ultimate offering terms. The application can incorporate a controlled sequence of tasks to ensure all parties complete their assigned responsibilities. The application can include manager approvals throughout the transaction and can provide the ability to manage multiple portfolios and offering scenarios within a single transaction, as well as selection of final deal terms to feed into other applications or systems.

In various embodiments, one or more software applications can implement an account and transaction management application, which can be used by originations, legal, and investment operations teams. The originations team can use the application to create new accounts for alternative asset holders and advisors. The legal team can use the application to review alternative asset holder-provided information for purposes of anti-money laundering or other efforts. The legal team can also use the application to provide deal terms required for the generation of trust and other documents. The investment operations team can use the application to compile and distribute transaction documents, including the binding term sheet and various plan documentation.

In various embodiments, one or more software applications can implement automated generation of trust documents using data provided by one or more other application described above, can implement distribution of trust documents to appropriate parties, and can implement creation and review of accounting journal entries. Various other functionalities can be implemented.

The embodiment of FIG. 11 is exemplary, and variations are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PLI, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A computer-implemented method comprising:
conveying an interest in an alternative asset from an alternative asset holder to a Custody Trust through a direct conveyance or a conveyance through at least one intermediate trust;
receiving by a Funding Trust loan proceeds from a loan provided by a lender to the Funding Trust, the lender having no interest in the alternative asset;
conveying at least a portion of the loan proceeds from the Funding Trust to an intervening trust;
acquiring consideration based on at least the portion of the loan proceeds; and
conveying the consideration to the alternative asset holder as remuneration for the interest in the conveyed alternative asset.

2. The computer-implemented method of claim 1, wherein the conveying of the interest in the alternative asset to the Custody Trust is a conveyance through two intermediate trusts.

3. The computer-implemented method of claim 2, wherein the lender has no control of the two intermediate trusts.

4. The computer-implemented method of claim 2, wherein the two intermediate trusts have a same trustee.

5. The computer-implemented method of claim 2, wherein the two immediate trusts include a Plan Custody Trust and a LiquidTrust, wherein the alternative asset holder is a beneficiary of the Plan Custody Trust and the LiquidTrust is a beneficiary of the Custody Trust.

6. The computer-implemented method of claim 1, wherein the Custody Trust and the Funding Trust are a same trust.

7. The computer-implemented method of claim 6, wherein the lender is one of: trustee of the Funding Trust and trustee of the intervening trust, or not trustee of either the Funding Trust or the intervening trust.

8. The computer-implemented method of claim 6, wherein the Funding Trust is a beneficiary of the intervening trust such that the Funding Trust holds a beneficial interest in the intervening trust, wherein the loan is secured by a percentage of the beneficial interest in the intervening trust.

9. The computer-implemented method of claim 1, wherein the consideration includes at least one of cash, marketable equity securities, or marketable debt securities.

10. The computer-implemented method of claim 1, further comprising conveying, from the Custody Trust to the Funding Trust, distributions from the alternative asset.

11. The computer-implemented method of claim 10, wherein the conveying the distributions from the alternative asset includes conveying from the Custody Trust to the Funding Trust through the at least one intermediate trust and through the intervening trust.

12. The computer-implemented method of claim 10, wherein at least a portion of the distributions is used by the Funding Trust to repay to the lender at least a portion of the loan proceeds.

13. The computer-implemented method of claim 10, wherein a beneficiary of the Funding Trust is a third-party entity.

14. The computer-implemented method of claim 13, wherein at least a portion of the distribution is distributed by the Funding Trust to the third-party entity.
